(19) United States
(12) Patent Application Publication
(10) Pub. No.: US 2008/0233930 A1
(43) Pub. Date: Sep. 25, 2008

(54) OPTIMIZED MESSAGING SERVICE-BASED MEDIA DELIVERY

(76) Inventors: Charles Stewart Wurster, San Diego, CA (US); Sachin Deshpande, San Diego, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/053,093

(22) Filed: Mar. 21, 2008

Related U.S. Application Data
(60) Provisional application No. 60/919,631, filed on Mar. 23, 2007.

(51) Int. Cl. H04Q 7/22

(52) U.S. Cl. 455/414.3

(57) ABSTRACT

Media can be optimized for delivery via a messaging paradigm to a plurality of mobile communications handsets. In some implementations, advertisements are coupled to the media and delivered in a single message. Such advertisements can also be optimized for the recipient mobile communications handset. Related apparatus, systems, methods, and articles are also described.

### RELATED APPLICATION

This application claims priority to U.S. Pat. App. Ser. No. 60/919,631 filed on Mar. 23, 2007, the contents of which are hereby fully incorporated by reference.

### TECHNICAL FIELD

The subject matter described herein relates to techniques and systems for the optimization and delivery of media to mobile phones.

### BACKGROUND

Over the past few years, there has been an explosive growth of messaging (particularly Short Messaging Service SMS) on mobile phones. This explosive growth began in Europe and Asia and has recently crossed-over into the United States. SMS has become so popular that many carriers now report their monthly SMS volume on their quarterly financial update press releases. However, SMS is limited to text. And as mobile devices are becoming increasingly sophisticated, the delivery of compelling rich media is now possible.

Multimedia Messaging Service (commonly known as MMS) enables the delivery of rich media including video, audio, images, and more. According to Tech Web, MMS is defined as an enhanced transmission service that enables graphics, video clips and sound files to be transmitted via cell phones. Content providers are looking for new ways to promote, utilize and monetize their multimedia content and the massive number of mobile devices is an exciting opportunity for them.

### SUMMARY

In one aspect, a request to initiate delivery of video content via a messaging services protocol to a mobile phone is received. Thereafter, the video content is obtained, and an advertisement associated with the request is obtained. One or more content delivery specifications for the mobile phone can be determined. Subsequently, at least a portion of the video content is combined with at least a portion of the advertisement to generate a merged content data file. The merged content data file substantially conforming to the determined content delivery specifications for the mobile phone. Lastly, delivery of a packet data unit encapsulating the merged content data file to the mobile phone via the messaging services protocol is initiated. The term advertisement refers to any secondary content that might be combined with another piece of content and not necessarily an offering for a product or service.

There are many variations which may be singly implemented or implemented in combination. For example, the messaging services protocol can be Multimedia Messaging Service. The advertisement can pre-pended to the video content such that the advertisement is displayed prior to the video content when the merged content data file is played on the mobile phone. The advertisement can be appended to the video content such that the advertisement is displayed subsequent to the video content when the merged content data file is played on the mobile phone. The advertisement can be inserted into the content such that a first part of the content is displayed, followed by the advertisement, and later by a second part of the content when the merged content data file is played on the mobile phone.

In addition, the one or more content delivery specifications for the mobile phone can be determined by associating the mobile phone with a device class, the device class prescribing video resolution limitations for a group of mobile phones class. A codec to encode the video content and the advertisement can be selected based on the video resolution limitations prescribed by the associated device class for the mobile phone. The one or more content delivery specifications for the mobile phone can additionally or alternatively be determined by predicting video settings for the mobile phone based on characteristics derived from metadata of the video content and/or based on previous encodings of the video content, such previous encodings being below a predetermined performance threshold, and/or based on performance characteristics for the mobile phone and/or based on characteristics derived from metadata of the video content. Audio settings can also be predicted for the mobile phone based on previous encodings of the video content, such previous encodings being below a predetermined performance threshold, and/or based on performance characteristics for the mobile phone.

The video content can be obtained by polling a source media database to obtain the requested video content. In some variations, the obtained video content can comprise at least two video clips having different display settings (e.g., resolution, duration, etc.), while in other variations only one video clip might be provided. The source media database can be populated with content grouped into content channels and/or content selected by a user of the mobile phone and/or content automatically harvested from the Internet (including specific websites).

In some implementations, a user can select a subset of the video content, wherein the subset of the video content is used to generate the merged content data file.

The advertisement can be obtained by polling an advertising media database to obtain the associated advertisement. The polling can be accomplished by associating one or more of the mobile phone and the requested video content with at least one key word; and querying the advertising media database with the at least one key word to obtain a matching advertisement.

The content delivery specifications can, for example, comprise one or more of media player resolution, file formats supported, video formats supported, video codecs supported, video bit rates supported, video frame rates supported, acceptable video key frame positioning, audio formats supported, audio codecs supported, audio data rates supported, audio channels supported, audio sample rate supported, maximum media time length supported, and maximum media file size supported.

In an interrelated aspect, a request to initiate delivery of multimedia content via a messaging service protocol to a plurality of mobile phones is received with a first subset of the mobile phones requiring the multimedia content to be encoded in a first format and a second subset of the mobile phones requiring the multimedia content to be encoded in a second format different than the first format. The plurality of mobile phones being grouped into device classes. Thereafter, the multimedia content can be obtained. Media can be iteratively encoded for each of the device classes, the media being encoded pursuant to content delivery specifications for the corresponding device class, the content delivery specifications based on the multimedia content, data characterizing prior encoding attempts for the delivery class, and performance characteristics for mobile phones within the corresponding device class. Subsequently, the encoded media corresponding to each device class can be encapsulated into packet delivery units. Delivery of the packet data units to corresponding the mobile phones via the messaging services protocol can then be initiated.

In yet a further interrelated aspect, a request to initiate delivery of video content via a messaging services protocol to a plurality of mobile phones is received. The video content in the request is obtained and each of the plurality of mobile phones is associated with a device class (each device class having one or more pre-defined content delivery specifications). The video content can then be encoded for each of the associated device classes, the video content having substantially maximum video resolution as limited by each device class and by message size limits prescribed by the messaging services protocol. Delivery of packet data units encapsulating the encoded video content to the corresponding mobile phones via the messaging services protocol can be initiated.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method for optimizing media delivery to a mobile phone;

FIG. 2 is a schematic diagram illustrating a system in which digital media specified by a content channel can be packaged and transmitted to a plurality of users so that the media is optimized for the handsets utilized by the users, and in some variations, advertisements can be inserted into and bundled to the digital media;

FIG. 3 is a process flow diagram illustrating a method of scheduling, encoding, and transmitting digital media to a plurality of users, and in some variations, insertion and bundling of advertisements; and

FIG. 4 is a process flow diagram illustrating a method of optimizing encoding of digital media for a plurality of handsets.

### DETAILED DESCRIPTION

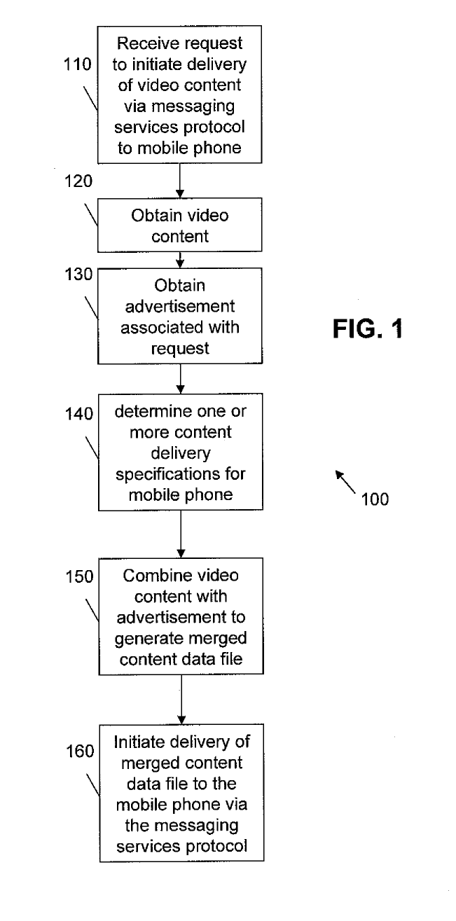

FIG. 1 is a process flow diagram illustrating a method 100, in which, at 110, a request to initiate delivery of video content via a messaging services protocol to a mobile phone is received. Thereafter, at 120, the video content is obtained, and at 130, an advertisement associated with the request is obtained. At 140, one or more content delivery specifications for the mobile phone can be determined. Subsequently, at 150, at least a portion of the video content is combined with at least a portion of the advertisement to generate a merged content data file. The merged content data file substantially conforming to the determined content delivery specifications for the mobile phone. Lastly, at 160, delivery of a packet data unit encapsulating the merged content data file to the mobile phone via the messaging services protocol is initiated.

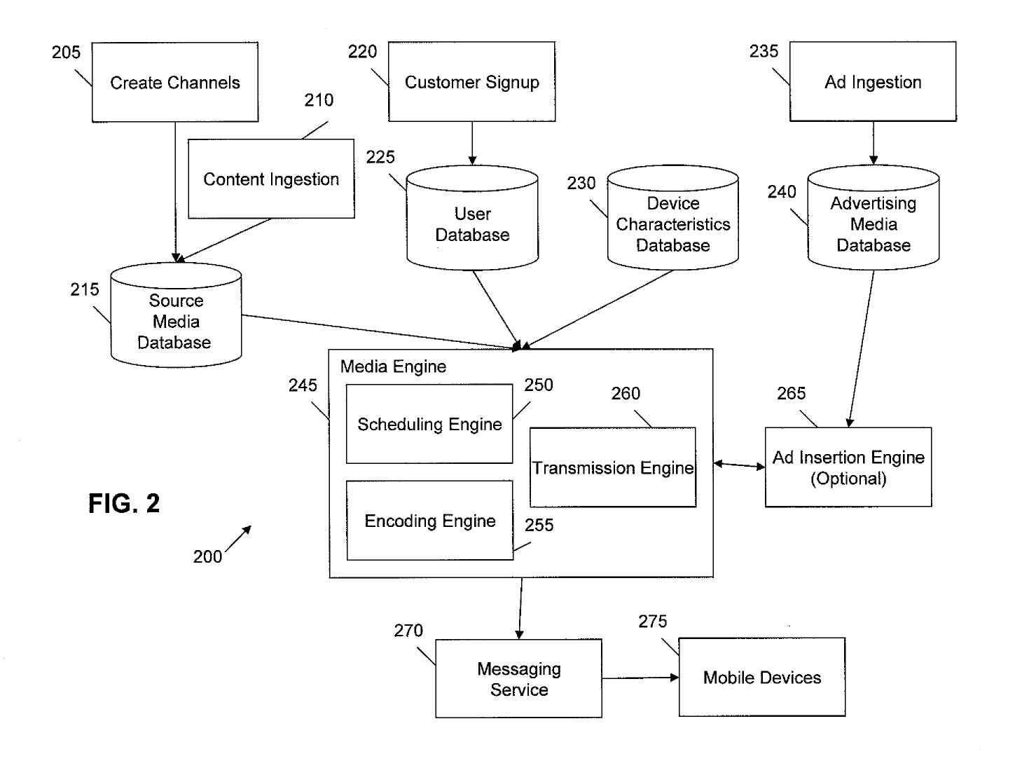

FIG. 2 is a diagram illustrating a system 200 that is centered around a Media Engine 245. The Media Engine 245 may comprise three components: a Scheduling Engine 250, an Encoding Engine 255, and a Transmission Engine 260. A user and/or a content provider may Create Channels 205 of content and/or a Content Ingestion 210 process may be initiated to populate content in a Source Media Database 215 coupled to the Media Engine 245. A User Database 225 may also be coupled to the Media Engine 245 and provide contextual information regarding a user obtained via a Customer Signup 220 process or otherwise. Similarly, the Media Engine 245 may be coupled to a Device Characteristics Database 230 which stores various information relating to types of mobile phones in order to allow for optimized and/or appropriate media to be pushed out to such mobile phones. In some implementations, the Media Engine 245 can be coupled to an Ad Insertion Engine 265 which provides advertisements obtained from an Advertising Media Database 240 to the Media Engine 245 for bundling with content. Such advertisements may be, for example, obtained via an Ad Ingestion process 235 (described below).

Within MMS content delivery, there are multiple ways for the content providers to expose their content to mobile devices. The first way can, for example, be to establish mobile content “channels” (e.g., Create Channels process 205) for users to subscribe to, for example, a sports fan might subscribe to a team channel that includes a collection of digital content about a particular team. These channels can be set up explicitly, like the sport team listing described above, or they can be systematically generated. For example a “Most Popular” channel is an example of a channel that can be systematically generated based on content that people are viewing on a web site or content that is known to be popular thru traditional media (i.e., content such as popular television shows, movies, music, etc.). These channels can either be managed by the content provider or by an end-user or agent. In some implementations, an agent can crawl through the content provider's (or third party) web properties and establish the channels automatically.

A second way for content providers to get their content to mobile devices can be to allow the users to pick individual content pieces to be delivered (e.g., Content Ingestion process 210). This arrangement allows the user to directly request individual content pieces and gives a more personalized experience. As the content pieces are delivered a record is kept of what content users were selecting. This information can then be used to establish a channel, and also to recommend additional relevant content pieces and channels for users. An example of this would be a web site that lets users view video clips and has a button that says send to my mobile, which initiates an immediate session to optimize the video for the user's mobile phone and send it to the user.

While the use of MMS as a delivery mechanism allows for enormous reach it does pose some technical challenges. On the content selection side, one side effect of these challenges is that only short clips (presently 30-45 sec on the high end devices and less on low end devices) can be delivered to the mobile devices; this is largely due to the file size limits imposed for MMS deliveries. Additionally mobile devices vary in their ability to display multimedia content (for example, some devices can display only 15 seconds of video, while others can do 45 seconds of video); this is due to the fact that different mobile phones have many heterogeneous content-enabling characteristics (i.e., different phones have different video codes, audio codecs, file size limitations, and many more discrepancies). Because of these differences in the mobile devices, it can be beneficial to have more than one length of a given clip available, for example a 15 second and 30 second version of the same material. This can allow one to send longer clips to the more capable devices and shorter clips to the less capable devices. The current system allows the content provider to group different lengths of clips together as a media set. The content provider can do this either by providing multiple pieces of content, providing a single piece of content and a set of start and end time for generating the shorter clips, some combination of the above, or by providing the content and allowing us to create the smaller clips for them either systematically or through human interaction. Additionally, in some implementations, the end user can pick the segment of the clip that they would like to have delivered. This is particularly true in the case where a user is individually selecting content instead of subscribing to a channel. Finally, the multimedia producer can pick the segment of the clip that they would like to have delivered. For example, many professional and amateur multimedia producers place their multimedia content on leading aggregation websites such as YouTube or MySpace; given the length limitation on many phones (i.e. some phones will only allow 30 second clips), producers may want to choose which segment of the clip they would like promoted to subscribers of this service.

In order for the system to be able to deliver requested content one needs to either have a copy of the content or know its location(s). This process is called Content Ingestion 210. The content provider delivers the media to a source media database (via a common file transfer message such as FTP, HTTP, or email), provides a URL indicating the locations, or allows the current system to crawl their website to locate the media. As described above the content provider can either provide multiple versions of the content providing multiple media or URLs, designations of start and end times, or an indication that one is allowed to shorten the clip on their behalf. In addition to the media sets the content provider provides, or allows us to generate, the subject line, message body, metadata about the clip set, channel this media set belongs to, and when this content should be delivered (now, scheduled for a particular time, to be determined later, etc). The metadata about the clip describes the content including general information about the content. For example type (sports, news, promotional, user generated), target audience (youth, teen, college, adult, etc.), keywords (funny, cats, kitten, pets, etc.), and the like. Such information can be used to associate appropriate advertising to it or to recommend other channels that have similar content. Additionally the metadata can include information describing the media itself, high motion, low motion, no motion, music, talking, etc. these metadata tags are used in the encoding process to help determine appropriate codecs and setting for a given media set. All of this information, referred to below as content (this include the media clip set, subject, message body, and metadata) can be stored in the Source Media Database 215.

One critical part of the system is end user acquisition. It does no good to have a system capable of delivering video to so many mobile devices around the world if there are no users who have requested to receive the content. Currently there are two basic mechanisms for user acquisition and content selection in the system. The first is user signup via an Internet site, either web based, or WAP (wireless access protocol, otherwise know as wireless web) based. The second is via the mobile device's messaging system.

Customer acquisition and content selection via an Internet site can be done either on the content provider's site, some site the content provider designates, through a site that one can create for them, or through a designated website. For some content providers, some variations provide for the automatic generation of a site by scanning the Content Provider's web or WAP site for applicable content. Independent of the details of the site's implementation the user must provide the following information (either explicitly or implicitly): content requested (either channels or individual pieces) phone number, carrier, device manufacturer, and device model. In some variations, the additional pieces of information can be collected such as: name, email address, birthday (or age), geographical information (whether it be full address information or partial information such as zip code), gender, and password. Optionally, one may include other demographic or psychographic (including interests, attitudes, views, lifestyles, etc.) information. By including a password the user can log back into the system and adjust the settings. The other information gathered is useful in delivering relevant content and advertising. Some sites may require that the user establish a login that includes some or all of these pieces of information. For those sites, the information may be gathered from the sites instead of directly from the user. In addition to gathering information from the site and user there exist systems that given the phone number of a mobile device are able to determine carrier, manufacturer, model, location, and billing information. It may be possible to use such a system to implicitly determine or verify some of these fields without asking the user for them. Customers can of course use the same site based mechanism to request that they stop receiving content.

Customer acquisition and content selection via messaging can be accomplished by having the user send a mobile originated message to a short code or email address with the subject and or content of the message (also referred to as a key word or key words) indicating what content is being requested. The system can use multiple short codes and or email addresses to imply individual content providers, content channels, and or individual pieces of content. Optimally, one can gather similar information described above via a site. As described above, one could poll a system with the phone number of a mobile device in order to obtain determine carrier, manufacturer, model, location, and billing information. Such a system can be used to implicitly determine or verify some of these fields without asking the user for them. It is possible in the current system to cross reference new content requests with the database of users using the phone number, and associate new requests for content with an existing user profile. Also, in some implementations where a content provider has a database of users that includes their phone numbers one may be able to gather other user information from the content provider's database. Customers can of course use the same messaging mechanism to request that they stop receiving content.

Information about the user (whether obtained via the Customer Signup process 220 or otherwise) and the content they have requested can stored in a database. In the current implementation, such a database can be referred to as the User Database 225.

One challenge that arises when attempting to send media to mobile devices is determining the types of media content that the devices will be able to play. In order to accomplish this, the Device Characteristics Database 230, which stores device characteristics can be provided. In some implementations, a primary Device Characteristic Database 230 can first be polled, and if relevant information for a particular mobile phone or group of mobile phones is not stored or available, then one or more secondary databases can be polled such as the WURFL database. Additionally, if the network carrier for a particular mobile phone is known, it may be possible to guesstimate a likely mobile phone based on stats for such network carrier (e.g., number of particular phone models sold overall by network carrier, type of phones used by users of the current system that are on the network carrier, etc.). Because of the complexity of the mobile device marketplace a given mobile device may have different characteristics depending on the mobile carrier that it is sold by, especially in the US where carriers customize the devices in an effort to add differentiating services. Additionally, the carriers may introduce limitations on the MMS messages that they are willing to carry over their network independent of the capabilities of the mobile device. By keeping a database that characterizes the mobile device models, and taking into account the variations introduced by the carrier, one can perform very specific optimizations. It is also important to note that the device characteristics may not match that device's MMS client's characteristics. For example, some devices may offer media players that support more formats that the MMS client installed on the device supports.

The Device Characteristics Database 230 can include information such as: MMS player resolution, file formats supported, video formats supported, video codecs supported, video bit rates supported, video frame rates supported, acceptable video key frame positioning, audio formats supported, audio codecs supported, audio data rates supported, audio channels supported, audio sample rate supported, maximum media time length supported, maximum media file size supported, for the each mobile device/carrier pair, and the like. In addition to this general information, the lowest acceptable settings for a given terminal and the settings beyond which no meaningful improvement in quality will be perceptible if they were to be increased can be stored.

With a system established that allows content providers to mobilize content and allows users to request to receive, the content can be optimally formatted for the users' mobile devices. Two basic types of content can be supported by the system (content channels, and individual content request). This can result in two basic classifications of media requests, requests where a large number of users are to receive the same content (channel requests) and requests that go to a single individual (individual requests). If a large number of people are requesting the same piece of individual content then the system may group those requests together and treat them as a channel request. A number of optimizations can be done when sending content to a large number of users that do not apply when sending to a single user.

The Scheduling Engine 250 can determine when content should be sent to the Encoding Engine 255 and when encoded content generated by the Encoding Engine 255 should be sent to the Transmission Engine 260. In some implementations, transmission by the Transmission Engine 260 can be started by the Encoding Engine 255 directly instead of by the Scheduling Engine 250 and/or one or more secondary processes can be inserted into the system before or after each of these main processes. One example of an optional secondary process/components is an Ad Insertion Engine 265 (described below). For content that is to go out as soon as possible the Scheduling Engine 250 attempts to send that content to the Encoding Engine 255 immediately. For pieces of content that are to be delivered at some point in the future it may not be appropriate to perform the encoding at the point in time when the content provider provides the media. In most cases the encoding can be done shortly before the content is to be sent out so that all of the potential users have an opportunity to sign up for the content. When the Scheduling Engine 250 determines that content should be processed it sends the content and the subscription information to the Encoding Engine 255.

In order to optimally format the content for a channel request the Encoding Engine 255 can determine, based on a User Database 225 accessible to the Media Engine 245, a list of users who have subscribed to this content (via a Customer Signup module 220). From that listing, the list of the user's devices can be assembled. The list of all the devices that are expected to receive the message can be obtained and the devices are then classified based on the information in a Device Characteristics Database 230. Because of the large number of different models of devices some devices, while being different models, may have identical characteristics and can be treated together as a single device class. This grouping of devices into classes is not required but can increase performance. This set of device classes represents the different encodings that need to be produced.

The Encoding Engine 255 can determine the maximum duration and file size of a given device class. Using such information, the Encoding Engine 255 can sort the terminals based on their restrictions with the most capable devices at the top of the list. This sorting is not require but can, in some circumstances, improve performance by increasing the likelihood that the previous iterations' settings should be similar. Further segmentation can occur at this point to group different device classes together based on other characteristics as well, including characteristics like the file formats supported.

At this point, the Encoding Engine 255 can iterate through all of the device classes in the list (or lists if additional segmentations occurred).

For each device class the Encoding Engine 255 can determine optimal output characteristics including, screen resolution, file format, video format, audio format, video codec, and audio codec to use for a given terminal based on the device characteristics. Optionally, metadata associated with the content can be used in the selection of the file format, video format, audio format, video codec, and audio codec. For example, if the metadata indicates that the content includes music a higher quality audio codec may be used.

Based on one or more of the previously mentioned characteristics, metadata, and information about previous attempts to encode this content if available (either unsuccessful attempts to encode for this device class or successful attempts for other devices classes in the list) the Encoding Engine 255 can determine which clip from the media set should be used. In some implementations, a media set might only contain a single clip. Alternatively, the Encoding Engine 255 may rank clips within media sets that have been successfully been transmitted and use the top ranking clip. Ranking may be effected, for example, based on criteria such as most often transmitted, least number of failure messages, and the like.

Next the Encoding Engine 255 can predict optimal video settings (video data rate, frame rate, key frame position) based on clip characteristics, codec selection, max file size, and previous results encodings of this or similar content using this codec. The maximum and minimum video settings for the current device can be retrieved from the Device Characteristics Database 230 (or obtained directly or implicitly or in code) and can be checked against the predicted settings (in some arrangements, there may not be a need to go beyond the maximum settings because quality may not improve meaningfully and no reason to go below the minimum setting because the video will be unusable). If maximum settings are exceeded then the settings are sent to the maximum and the Encoding Engine 255 proceeds. If the predicted settings are below the minimum settings then the Media Engine 245 records a failed attempt and starts processing this device class again with the next smaller clip in the media set (or alternatively, exits out of the process altogether).

Thereafter, the Encoding Engine 255 can determine predicted optimal audio settings (audio data rates, audio channels, audio sample rate) based on clip characteristics, codec selection, max file size, predicted size of encoded video, and previous results encodings of this or similar content using this codec. The maximum and minimum audio settings for the current device can be retrieved from the Device Characteristics Database 230 (or obtained directly or implicitly or in code) and can be checked against the predicted settings (there is no need to go beyond the maximum settings because quality may not improve meaningfully and no reason to go below the minimum setting because the audio will be unusable). If maximum settings are exceeded then the settings are sent to the maximum and the Encoding Engine 255 proceeds. If the predicted settings are below the minimum settings then the Encoding Engine 255 can record a failed attempt and can either start processing this device class again with the next smaller clip in the media set or reports a failure to the previous step and attempts to reduce the video settings. Optionally, the Encoding Engine 255 may attempt to select a lower quality audio codec in some situations. Another option is to reverse the order of the determination of the video and audio settings. This would result in improved audio quality at the expense of the video quality. An additional advantage of configuring the audio first is that the audio in general make up a smaller portion of the output file than the video and modifications to the audio settings are unlikely to greatly affect the file size.

The Encoding Engine 255 can perform the encoding with the determined settings. Once the encoding is finished the Encoding Engine 255 can check the output of the encoder to determine if the encoded media meets the requirements of the device class. Additionally, the quality of the encoding can be verified by a person or tested automatically as described below. Because a number of settings are determined using heuristics it is possible that the encoded media may exceed the file size limitations of the device class. If this occurs the media will need to be re-encoded. It is also possible that the heuristics may have resulted in an encoded media that is enough smaller than the maximum file size that it should be re-encoded with higher settings (if the maximum settings were used this is of course ignored). If the media needs to be re-encoded the Encoding Engine 255 can start again with this device class and the results of the failed encoding (these results may include the reason(s) for failure, the settings that were used, and other details about the encoding).

In the event that the encoding was successful the Encoding Engine 255 can move on to the next device class in the list and begin again with settings and results of this successful encoding.

There can be some minor differences that can occur when handling individual requests, instead of channel requests. The advantage gained by knowing the results of encoding the same piece of content for a given device type can potentially be lost and there is only one device class that needs to be considered. It is possible to design the system so that popular pieces of content are recognized and are stored for some period of time after having been encoded for a device class. Additionally, for such content, one can store the settings used so that the advantage gained by multiple encodings is preserved.

Once the Encoding Engine 255 has finished encoding all of the content the Scheduling Engine 250 may initiate the Transmission Engine 260. Optionally, the Transmission Engine 260 can be started for a given device class as soon as the content is successfully encoded. For some lower end devices the Encoding Engine 255 may not be able to create an acceptable encoding of the content. Additionally, some very low end devices may not be able to support video at all. In these cases, either the text portion of the message may be sent or the message may be discarded.

The Transmission Engine 260 can prepare the optimized media for delivery. Using the same information about subscribers and their device classes that was provided to the media engine and the results of the Encoding Engine 255, the Transmission Engine 260 can prepare the content for delivery. There is more than one way to deliver the message to the carrier network. The first is to communicate directly with the carrier MMS Gateway or Multimedia Messaging Center (MMSC). This can be done using a variety of protocols including, SMTP, SMPP, UCP/EMI, MMT, and HTTP connections. The second way is to deliver the messages to a third party designated by the carrier to handle messaging requests. This can also be done using a variety of protocols including, SMTP, SMPP, UCP/EMI, MMT, and HTTP connections. Different carriers and third party providers sometimes prefer to have the messaging requests in different formats. Some protocols allow a single message to be sent to a large number of devices, others have limitation on the number of mobile devices that can be simultaneously addressed. For each carrier, based on acceptable parameters and protocols for the carrier, or its third party provider, the Transmission Engine 260 can assemble a messaging request in the proper format and includes the subject, body, and media for a given device class and either send it off immediately or queue it until all of the messages are ready. This can be repeated for each device class and carrier until all of the messages with optimized multimedia have been sent.

Content providers seek new ways to utilize and monetize their inventory. This can be done in a number of ways including charging the end user. One technique to monetize multimedia content is to include advertising in the multimedia content to enable subsidized content delivery. In the current context, advertisement refers to any image, video, and/or audio that is complementary to a primary image, video, and/or audio clip and need not strictly relate to a conventional product or service advertisement (i.e., the term advertisement as used herein simply refers to a second piece of media). There are a couple of inherent issues that need to be addressed when looking at inserting advertising content in a system like the one that has been described. Sending every person the same advertisement is undesirable, it is much better to send an advertisement that is relevant to the customer. Sending a unique advertisement to each user poses technical challenges. It is considerably less resource intensive to send every user the same advertisement. This is true in the encoding process as well as the transmission process.

When digital content is organized into a content channel, the solution described below increases relevance while limiting the resource burden. With such an arrangement, an advertisement (video, image, and or text) can be associated with a set of subscribers to a particular piece of content on a given content channel. By breaking up the subscribers into sets tradeoffs can be made between resource use and relevance. As the number of sets are increased, the number of different advertisements that can be associated with a particular piece of content can be increased.

Before the creation of the sets are described, it can be specified how the advertisements can be added to the system. Ad Ingestion 235 can be handled by the system in much the same way content is handled. Initially advertisements and any related information characterizing such advertisements can be stored in the Advertising Media Database 340. Like content, advertisements can include a media set, except in this case the specific advertising media set is expected to have much shorter lengths (for example, 10 seconds, 5 seconds, and a still frame). In addition to this media set, the ad provider provides the start and end dates of the ad campaign, metadata about the ad, requested demographics (or psychographics), requested time of day for delivery, requested content metadata, associated message to add to the message text, number of impressions requested, any limitations (for example, no more than x views on a given channel, restrictions on the type of content acceptable, restrictions on the acceptable content providers, etc.), and the economic terms of the advertisement. The metadata about the ad can describe the target market of the ad (youth, teen, college, adult, etc.), the type of product being advertised, the company that is being advertised, the product being advertised, any keywords associate with the ad, and the like. This metadata can be used to better match advertisements to users and content and to allow content providers to exclude advertisements that would be deemed inappropriate. The requested content metadata can allows advertisers to specify content that they would like to be associated with, for example a deodorant company may prefer to appear with content of type sports and keyword bloopers.

The Ad Insertion Engine 265 can determine how many sets to create, which users belong which sets, and handles merging the ads with the content. The sets can be determined either by starting with the information available about the users or about the available advertisements. In the case where the groups are created by starting with user information, the demographic information (either gathered or implied) can be used from the User Database 225, the types of content users have requested, psychographic indications, records of how many times users have received a given advertisement or advertiser, among other things. The sets can also be established by starting with information about the available advertisements including: economic incentive (amount advertiser is willing to pay to deliver the ad), content metadata that the advertiser has requested to be associated with, preferred customer demographics (either gathered or implied), etc.

Once the sets have been established the advertisement can be associated with a given set. The advertisement then gets merged with the content; this can be done as by prepending the advertisement, appending the advertisement, or inserting the advertisement into the content (interstitial). For each set of users, the Ad Insertion Engine 265 can merge items from the ad content sets to appropriate content set items. There are a number of ways to decide which items in the content set get merger with which items from the ad set. One way to do it is create all possible combinations of merged sets. If you start with 2 pieces of media in the content set and 3 pieces of media in the ad set this would result in a final media set of 6 pieces. In the present system, the following general rules can, for example, be utilized: Long content should have long ads and short ads, Moderate length content should get both long and short ads, if the duration of moderate length content with a with long ad is more than long content with short ad it should not be considered, only the shortest Content should get the still image if present. This method for picking what ads to associate with what content favors quality of content over ad length.

In the event that ad integration is used, one way to integrate it into the system is to have it run immediately before the Encoding Engine 255 is started. The Encoding Engine 255 can then be started with the content generated by the Ad Insertion Engine 265 instead of the content it would have otherwise been given.

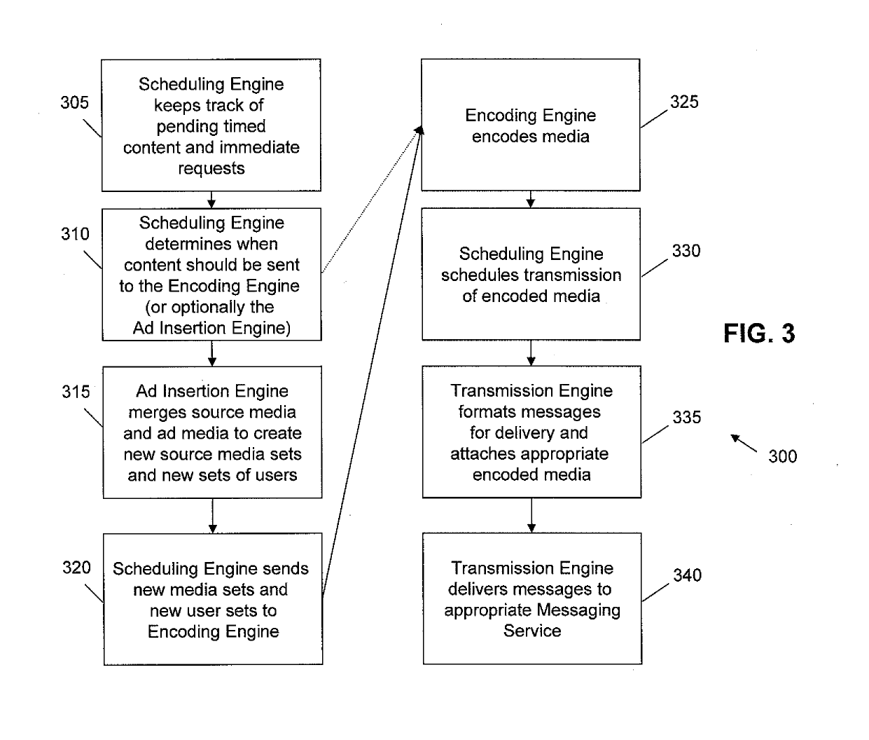

FIG. 3 is a process flow diagram illustrating a method 300, in which, at 305, the Scheduling Engine 250, keeps track of pending timed content requests and requests for immediate content delivery. Thereafter, at 310, the Scheduling Engine determines when the content should be sent to the Encoding Engine 255, or in some implementations, to the Ad Insertion Engine 265. With the former arrangement, at 325, the Encoding Engine 255 subsequently encodes the media. Otherwise, at 315, the Ad Insertion Engine 315 merges source media and ad media to create new source media sets and new sets of users followed by, at 320, the Scheduling Engine 250 sending the new media sets and the new user sets to the Encoding Engine 325 for encoding. In either arrangement, after the media is encoded, at 330, the Scheduling Engine 250 schedules transmission of encoded media. The Transmission Engine 260 then, at 335, formats messages for delivery and attaches appropriate encoded media (e.g., the Transmission Engine 260 generates a packet data unit encapsulating the media). Thereafter, at 340, the Transmission Engine 260 delivers the messages to an appropriate Messaging Service 270.

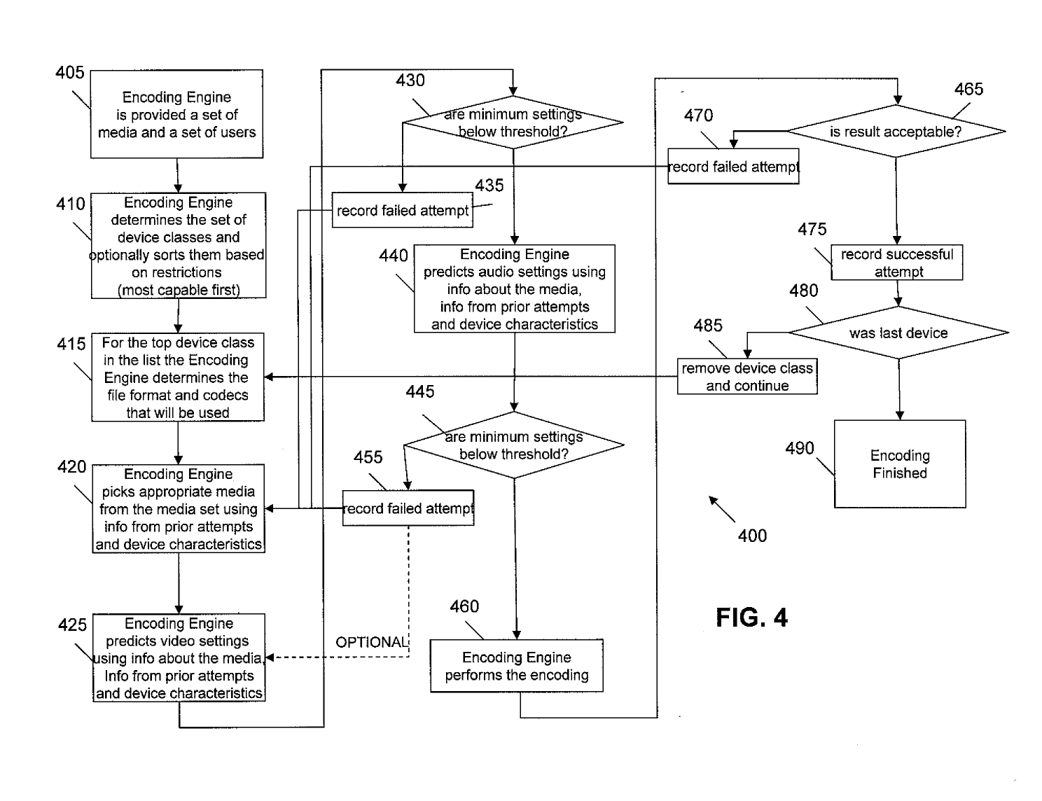

FIG. 4 is a process flow diagram illustrating a method 400, in which, at 405 Encoding Engine 255 is provided a set of media and a set of users. The Encoding Engine 255 then, at 410, determines the set of device classes and sorts these classes based on their restrictions (with most capable device classes being ranked higher). For the top device class in the list, the Encoding Engine 255, at 415, determines the file formats and codecs that will be used for this device class. In addition, the Encoding Engine 255, at 420, selects appropriate media from the media set using information characterizing prior attempts to deliver such media and based on device characteristics. The Encoding Engine 255, at 425, subsequently predicts video settings using information about the media, information about prior attempts to deliver such media and using the device characteristics. If the minimum settings are determined, at 430, to be below a minimum performance threshold, then a failed attempt is recorded at 435, and the Encoding Engine 255, at 420, once again selects appropriate media from the media set. If the minimum settings are not below a performance threshold, then at 440, Encoding Engine 255 predicts audio setting using information about the media, information from prior attempts, and device characteristics. If at this stage, if it is determined, at 445, that the minimum settings are below a performance threshold, then at 455, a failed attempt is recorded, and the Encoding Engine 255, at 420, once again selects appropriate media from the media set, or alternatively, the Encoding Engine 255, at 425 once again predicts video settings. Otherwise, at 460, the Encoding Engine 255, at 460, performs the encoding. At 465, it is determined whether the encoding of the media meets certain criteria. If the result is not acceptable, at 470, a failed attempt is recorded, and the Encoding Engine 255, at 420, once again selects appropriate media from the media set. Otherwise, at 475, a successful attempt is recorded. If is determined at 480 that the device was the last device within the device class, then at 490, the encoding is finished. If the device was not the last device class within the set of device classes, then at 485, the device class is removed and the process continues for the next device class.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a mobile communications device or computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claim.

What is claimed is:

1. A computer-implemented method comprising:
receiving a request to initiate delivery of video content via a messaging services protocol to a mobile phone;
obtaining the video content;
obtaining an advertisement associated with the request;
determining one or more content delivery specifications for the mobile phone;
combining at least a portion of the video content with at least a portion of the advertisement to generate a merged content data file, the merged content data file substantially conforming to the determined content delivery specifications for the mobile phone; and
initiating delivery of a packet data unit encapsulating the merged content data file to the mobile phone via the messaging services protocol.

2. A method as in claim 1, wherein the messaging services protocol is Multimedia Messaging Service.

3. A method in claim 1, wherein the advertisement is pre-pended to the video content such that the advertisement is displayed prior to the video content when the merged content data file is played on the mobile phone.

4. A method as in claim 1, wherein the advertisement is appended to the video content such that the advertisement is displayed subsequent to the video content when the merged content data file is played on the mobile phone.

5. A method in claim 1, wherein a first portion of the advertisement is displayed prior to the video content and a second portion of the advertisement is displayed subsequent to the video content when the merged content data file is played on the mobile phone.

6. A method as in claim 1, wherein the determining one or more content delivery specifications for the mobile phone comprises:
associating the mobile phone with a device class, the device class prescribing video resolution limitations for a group of mobile phones class.

7. A method as in claim 6, further comprising:
selecting a codec to encode the video content and the advertisement based on the video resolution limitations prescribed by the associated device class for the mobile phone.

8. A method as in claim 1, wherein the determining one or more content delivery specifications for the mobile phone comprises:
predicting video settings for the mobile phone based on one or more of characteristics derived from metadata of the video content, previous encodings of the video content, such previous encodings being below a predetermined performance threshold, and performance characteristics for the mobile phone.

9. A method as in claim 1, wherein the determining one or more content delivery specifications for the mobile phone comprises:
predicting audio settings for the mobile phone based on one or more of characteristics derived from metadata of the video content, previous encodings of the video content, such previous encodings being below a predetermined performance threshold, and performance characteristics for the mobile phone.

10. A method as in claim 1, wherein the obtaining the video content comprises:
polling a source media database to obtain the requested video content.

11. A method as in claim 1, wherein the obtained video content comprises at least two video clips having different display settings.

12. A method as in claim 11, wherein at least a subset of the video clips have different durations.

13. A method as in claim 1, further comprising: receiving user-generated input selecting a subset of the video content, wherein the subset of the video content is used to generate the merged content data file.

14. A method as in claim 10, wherein the source media database is populated with content grouped into content channels.

15. A method as in claim 10, wherein the source media database is populated with content selected by a user of the mobile phone.

16. A method as in claim 10, wherein the source media database is populated with content automatically harvested from the Internet.

17. A method as in claim 1, wherein obtaining the advertisement associated with the request comprises:
polling an advertising media database to obtain the associated advertisement.

18. A method as in claim 1, wherein polling the advertising media database comprises:
associating one or more of the mobile phone and the requested video content with at least one key word; and
querying the advertising media database with the at least one key word to obtain a matching advertisement.

19. A method as in claim 1, wherein one or more of the content delivery specifications are selected from a group comprising: media player resolution, file formats supported, video formats supported, video codecs supported, video bit rates supported, video frame rates supported, acceptable video key frame positioning, audio formats supported, audio codecs supported, audio data rates supported, audio channels supported, audio sample rate supported, maximum media time length supported, and maximum media file size supported.

20. A computer-implemented method:
receiving a request to initiate delivery of video content via a messaging services protocol to a mobile phone;
obtaining the video content;
obtaining secondary content associated with the request;
determining one or more content delivery specifications for the mobile phone;
combining at least a portion of the video content with at least a portion of the secondary content to generate a merged content data file, the merged content data file substantially conforming to the determined content delivery specifications for the mobile phone; and
initiating delivery of a packet data unit encapsulating the merged content data file to the mobile phone via the messaging services protocol.

21. A method as in claim 20, wherein the secondary content is an advertisement.

22. A computer-implemented method comprising:
receiving a request to initiate delivery of multimedia content via a messaging service protocol to a plurality of mobile phones, a first subset of the mobile phones requiring the multimedia content to be encoded in a first format, a second subset of the mobile phones requiring the multimedia content to be encoded in a second format different than the first format, the mobile phones being grouped into device classes;
grouping the plurality of mobile phones into device classes;
iteratively encoding media for each of the device classes, the media being encoded pursuant to content delivery specifications for the corresponding device class, the content delivery specifications based on the multimedia content, data characterizing prior encoding attempts for the delivery class, and performance characteristics for mobile phones within the corresponding device class;
encapsulating the encoded media corresponding to each device class into packet delivery units; and
initiating delivery of the packet data units to corresponding the mobile phones via the messaging services protocol.

23. A computer-implemented method comprising:
receiving a request to initiate delivery of video content via a messaging services protocol to a plurality of mobile phones;
obtaining the video content;
associating each of the plurality of mobile phones with a device class, each device class having one or more pre-defined content delivery specifications;
encoding the video content for each of the associated device classes, the video content having substantially maximum video resolution as limited by each device class and by message size limits prescribed by the messaging services protocol; and
initiating delivery of packet data units encapsulating the encoded video content to the corresponding mobile phones via the messaging services protocol.
